(19) United States
(12) Patent Application Publication
(10) Pub. No.: US 2006/0203736 A1
(43) Pub. Date: Sep. 14, 2006

(54) Real-time mobile user network operations center

(75) Inventors: Brett Thomas Molen, West Jordan, UT (US); Jim S. Elliot, Park City, UT (US); Justin L. Powell, Sandy, UT (US); George B. Norr, Midvale, UT (US)

Correspondence Address: BEYER WEAVER & THOMAS, LLP, P.O. BOX 70250, OAKLAND, CA, 94612-0250, US

(73) Assignee: STSN General Holdings Inc., Salt Lake City, UT (US)

(21) Appl. No.: 11/078,908

(22) Filed: Mar. 10, 2005

(51) Int. Cl. H04L 12/26

(52) U.S. Cl. 370/245

(57) ABSTRACT

Methods and apparatus are described for monitoring mobile computing devices configured for operation in a home network. Mobile user data are accumulated which relate to operation of each of the mobile computing devices on at least one remote network which does not include any part of the home network. A representation is generated of the mobile user data for each of the mobile computing devices which is capable of being presented in a network operations center (NOC) interface substantially in real time.

### BACKGROUND OF THE INVENTION

The present invention relates to techniques for tracking the computers of business travelers and, more specifically, to providing corporate IT personnel with visibility into the machines of their mobile users.

Corporate IT managers spend tremendous amounts of time, money, and resources creating reliable and secure network environments for their users. A vast array of sophisticated tools enable IT personnel to monitor and control the behavior of users, the configuration of machines, and the enforcement of corporate IT policies on their corporate intranets. Tools such as Hewlett Packards's OpenView Management Software provide corporate NOCs with near real-time data on network usage. However, the business necessity of providing support for mobile “road warrior” users often defeats many of the safeguards IT personnel so painstakingly put in place.

The Travel Industry Association of America (TIA) estimates that Americans made more than 140 million business-related “person-trips” in 2004. A survey of business travelers in 2003 found that 81% were taking a laptop with them. These numbers do not even account for the estimated 1 billion non-business-related trips, a good proportion of which Americans travelers are likely to have taken company laptops with them.

While on such trips, mobile users often connect with networks in hotels, conference centers, and Internet cafés which provide little or no security for important company data on their machines. These users often will make changes to the configuration of their machines, download software from suspect sources, connect to the Internet without using the company's VPN, disable firewalls, and generally use their machines in ways which violate the IT policies on their home networks. Not only does the behavior of the typical business traveler compromise the security of sensitive corporate data on his own machine, it also presents serious security risks to the home network when the business traveler returns with the compromised machine.

It is therefore desirable to provide tools and techniques by which corporate IT personnel can monitor, support, and control the behavior of their mobile users.

### SUMMARY OF THE INVENTION

According to the present invention, a variety of tools and techniques provide corporate IT personnel with near real-time visibility into the computing behavior of their mobile users, and the ability to remotely support and/or control such behavior. This may be done regardless of where and how these mobile users are connecting to the Internet. According to a specific embodiment, methods and apparatus are provided for monitoring mobile computing devices configured for operation in a home network. Mobile user data are accumulated which relate to operation of each of the mobile computing devices on at least one remote network which does not include any part of the home network. A representation is generated of the mobile user data for each of the mobile computing devices which is capable of being presented in a network operations center (NOC) interface substantially in real time.

Depending on the characteristics of the network environment to which mobile users connect, additional functionalities may be realized. According to one such embodiment, a network is provided having an access node which is operable to receive packets from a plurality of mobile computing devices attempting to access the network. The mobile computing devices are configured for operation in a home network which is separate from the network. The access node is configured to transmit all of the packets received from the mobile computing devices to a gateway on the network regardless of destination addresses associated with the packets. The gateway is operable to receive mobile user data relating to operation of each of the mobile computing devices on the network and facilitate generation of a representation of the mobile user data for each of the mobile computing devices which is capable of being presented in a network operations center (NOC) interface substantially in real time.

A further understanding of the nature and advantages of the present invention may be realized by reference to the remaining portions of the specification and the drawings.

### BRIEF DESCRIPTION OF THE DRAWINGS

FIG. 1 is a diagram of an exemplary network environment in which embodiments of the invention may be implemented.

FIG. 2 is a flowchart illustrating a specific embodiment of the invention.

FIG. 3 is a simplified block diagram of an exemplary background application and associated modules for use with specific embodiments of the invention.

FIG. 4A-4D are exemplary screenshots illustrating interfaces for monitoring mobile users according to a specific embodiment of the invention.

FIG. 5 is a diagram of another exemplary network environment in which embodiments of the invention may be implemented.

FIG. 6 is a flowchart illustrating another specific embodiment of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

According to the present invention, corporate IT personnel are provided with data (e.g., status, location, performance, security, and other data) for each of their mobile users in near real-time no matter where or how those mobile users are connecting to the Internet. According to some implementations, a service, an application, or set of services, applications, and associated modules on each user's machine run(s) in the background gathering and then transmitting these data to a central location or service for storage in an associated database. According to other embodiments, a remote application may gather these data when the user's machine is online. This could be implemented like an application service provider (ASP) model in which the user logs on when connecting with a network.

Corporate IT personnel are then provided access to the data for their users. This may be accomplished using, for example, a hosted platform in which access to the data is provided via a web interface. Alternatively, these data may be transmitted directly to the home network. In any case, whatever mechanism is employed to provide access to these data, the “road warrior NOC” of the present invention enables corporate IT personnel to monitor and/or support their mobile users in new and powerful ways.

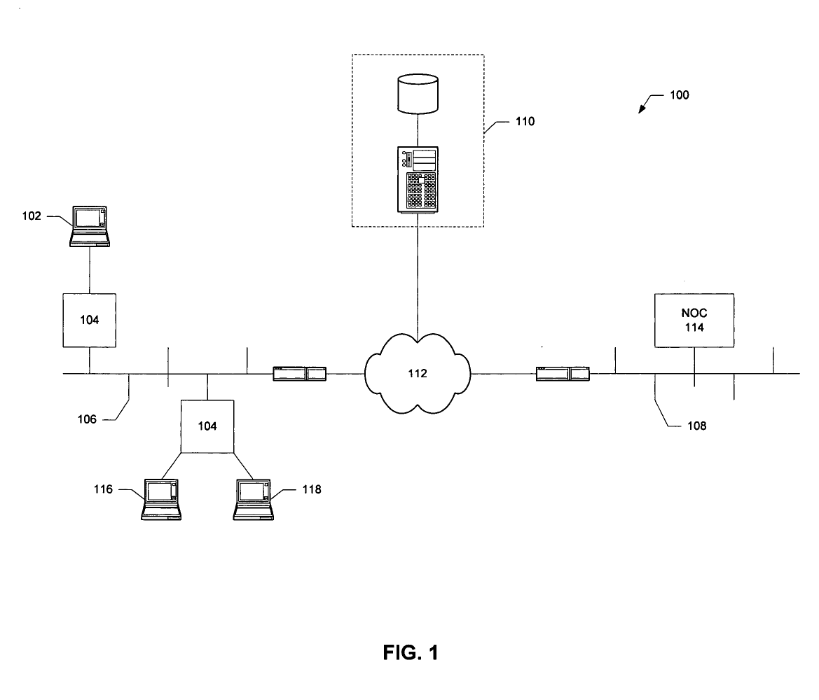

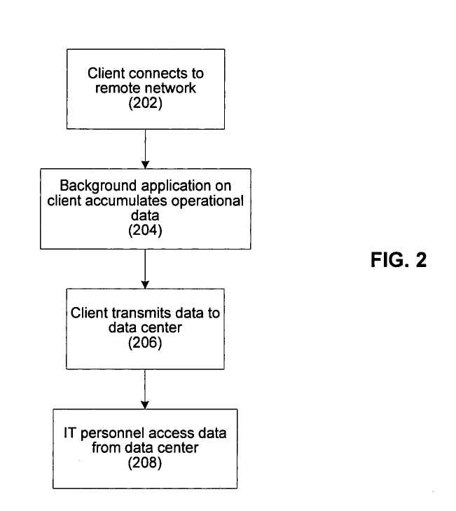

FIG. 1 shows an exemplary network environment 100 for the purpose of illustrating specific embodiments of the invention. FIG. 2 is a flowchart illustrating one such embodiment. A mobile client machine 102 connects to a network access node 104 (e.g., a wireless access point (WAP)) on a network 106 which is remote from its home network 108 (202). One or more applications (e.g., a Windows NT service and associated modules) running in the background on client 102 accumulate data relating to the operation of client 102 (204) and transmit the data to a remote data center 110 via network 106 and the Internet 112 (206). It should be noted that the “one or more applications” will often be referred to herein in the singular, i.e., as “the background application.” However, it should be understood that this is merely for the sake of simplicity and should not be used to limit the scope of the invention.

According to some implementations, the background application operating on the client device communicates with the NOC in a secure manner. This may be achieved, for example, using an encrypted tunnel (e.g., IPsec tunnel) between the mobile device and the NOC for all communications. It will be understood that a wide variety of other techniques for conducting communication between the mobile device and the NOC may be employed.

Corporate IT personnel (represented by NOC 114 on home network 108) access the accumulated data from data center 110 via Internet 112 (208) using, for example, a secure web interface which allows the IT personnel to monitor each of their remote users (e.g., client machines 116 and 118). Alternatively, the accumulated data may be transmitted directly to NOC 114. It should be understood that the mobile user data may be accessed at locations remote from the home network, e.g., by IT personnel who are also using mobile devices or who are connecting from home.

It should be understood that the devices and network of FIG. 1 are merely exemplary and that many alternatives of each may be employed to implement various embodiments of the invention. For example, client machine 102 may be any of a wide variety of mobile computing devices including, for example, laptop computer, handheld devices, PDAs, etc. In addition, any of a variety of conventional and proprietary architectures and devices may be employed for networks 106 and 108, data center 110, and NOC 114 to implement the various functionalities described with reference to those elements of FIG. 1.

According to various embodiments of the invention, a wide range of data relating to various aspects of mobile device operation may be accumulated for a wide range of purposes. For example, detailed information relating to the nature of the network to which the mobile device is connecting may be generated. For example, the background application (and/or any associated modules) could determine whether the IP addresses associated with the network are public or private, with private being preferred from a security standpoint. In addition, the background application could cause probes to be transmitted on the network to determine whether any other devices on the network may be detected. If any such devices successfully respond to such probes, this could indicate an unacceptable security risk. Further probes of responding devices could be effected to determine the nature or magnitude of the risk. In any case, it will be understood that a wide variety of information relating to security could be determined regarding the nature of the network, the information then being processed appropriately for presentation on the NOC.

Information relating to the security of the mobile device may also be generated. For example, the background application may determine whether the device has a firewall installed, and whether the firewall is currently enabled. This could be accomplished, for example using tie ins with industry standard firewalls and their logs. Similarly, information relating to the virus defense of the mobile device may be generated, e.g., is anti-virus software installed? Is it enabled? Has it been updated recently? Whether software is enabled could be determined, for example, by determining what processes are currently running (e.g., with reference to the current task list) on the mobile device.

Software version information could be determined, for example, with reference to the signature file numbers associated with the particular anti-virus software. This information could be collected and stored at the NOC and then pushed out to the client device at the request of the background application. According to specific embodiments, where it is determined that the mobile device does not have the most current version of the software being evaluated (whether anti-virus or some other software), the actual updates could either be pushed from or their installation facilitated by the NOC.

Information relating to the spyware status of the mobile device may also be accumulated. For example, the background application may determine whether spyware detection software is installed, when the last scan for spyware occurred, and whether any commonly known infections were detected. Many of the techniques described above with reference to viruses may also be applicable in this context. For example, the NOC could integrate with large spyware detection providers to determine whether updates are necessary and to effect such updates. In addition, infections could be detected by looking at what processes are currently running or at firewall logs.

The background application could also determine and report on what ports are currently open. That is, because spyware and viruses often open up ports to transmit information, a report on the ports open may be used to determine whether a device has been infected.

The background application might also determine whether the mobile device is running the virtual private network (VPN) dictated by its company's IT policies, i.e., whether the VPN is installed and/or being used. Again, by looking at what processes are currently running on the mobile device, the background application should be able to determine whether the VPN is being used and, if not, generate an alert to the NOC.

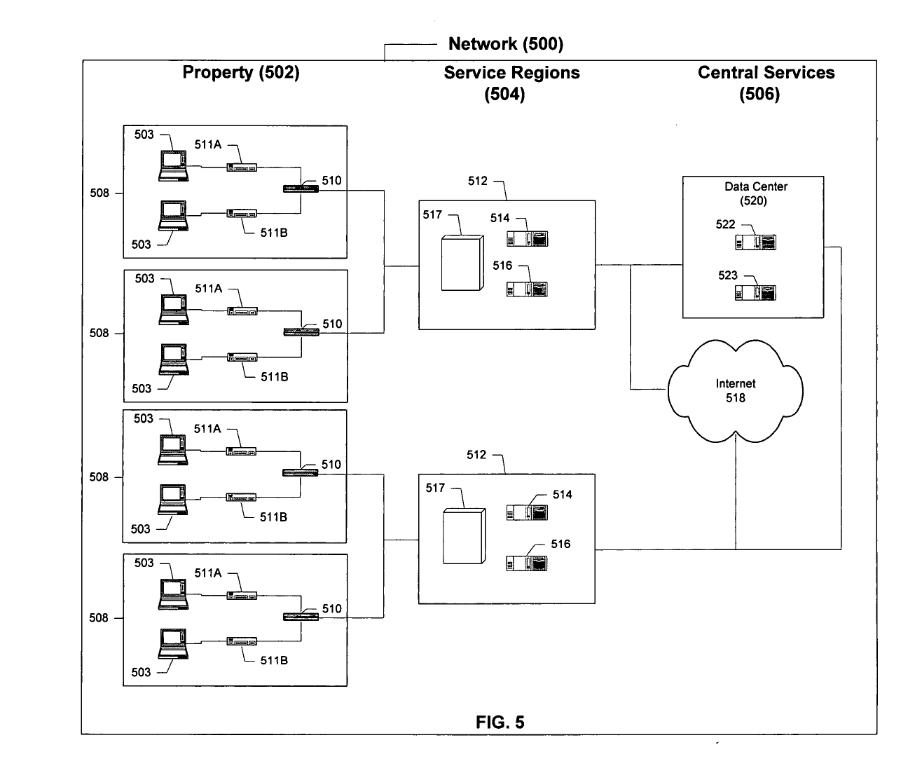

The background application may also be operable to provide location information so that mobile users may be tracked geographically. If a mobile user is on a network affiliated in some way with the NOC (e.g., see network 500 of FIG. 5), a very precise location of that user may be provided. This could be very useful if, for example, a company laptop is stolen and the thief attempts to connect to such a network. If, on the other hand, a mobile user is at some random, unaffiliated location, e.g., an Internet café, other techniques may be employed to identify the location. For example, it is possible to estimate location with reference to the source IP address of packets on the network to which the mobile user is connected. Using this information, a lookup can determine to whom the address is registered, and further searching can identify at least one location corresponding to the registrant.

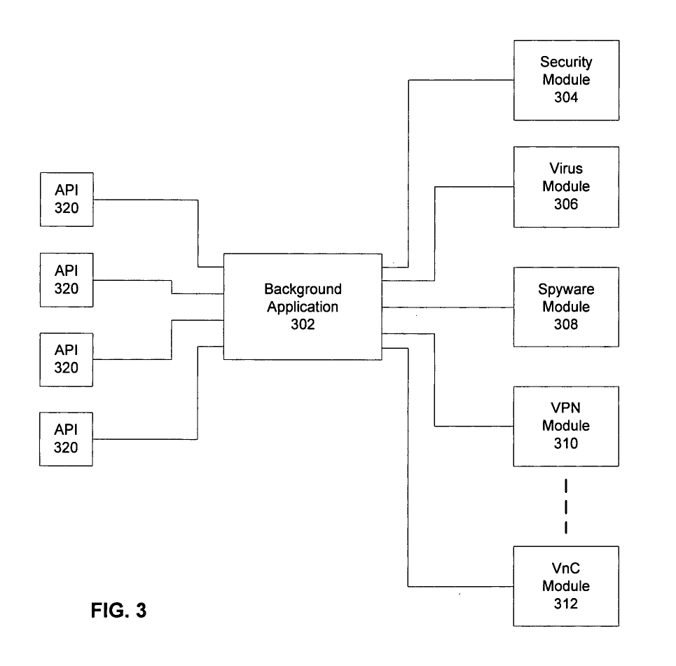

According to a specific embodiment illustrated in FIG. 3, the background application on the mobile device comprises a base application 302 and any of a plurality of modules (e.g., security module 304, anti-virus module 306, spyware module 308, VPN module 310, etc.) depending upon the type of mobile user data to be monitored and/or collected. The base application 302 may comprise, for example, a Windows NT service which runs in the background and looks for events which, when detected, will trigger operation of one or more of the associated modules which perform one or more tests and report back to base application 302. For example, when a mobile user connects to a network away from the home network (e.g., by entering a wireless hot spot or by plugging into wired port), this event would be detected by base application 302 which would then trigger operation of security module 304 which might, for example, check the security of the network to which the user is connecting, determine whether the user's firewall is enabled, etc.

Base application 302 may also be configured to generate alerts in response to the results of the operation of the various associated modules. That is, for example, in response to the security module 304 determining that the mobile device has connected to an unsecure network, base application 302 may generate an alert which is transmitted to the NOC for presentation to IT personnel via whatever NOC interface is employed. Similarly, if a virus or spyware infection is detected, or if the anti-virus or anti-spyware software has been disabled, base application 302 would generate alerts to the NOC. Alternatively, these alerts may be generated by the individual modules rather than the base application.

According to some embodiments, the base application 302 is extensible, including APIs 320 to which IT personnel can program and connect their own modules for any desired functionality. For example, the IT policies for a given enterprise might make it desirable to include a module for the mobile users of that enterprise which monitors specific metrics of interest in response to any of the events that the base application is configured to detect.

As discussed above, one of the goals of specific embodiments of the invention is to enable IT personnel to provide remote support for their mobile users. A conventional mechanism for doing this is using a technique known as virtual network computing (VNC) which enables a user, e.g., desktop support personnel, on one device to take over control of a remote device, e.g., the laptop of a mobile user. However, there are security issues relating to having a VNC connection open all the time. Therefore, according to a specific embodiment, a specific event detected by the base application 302, e.g., a request from a remote desktop support person, may trigger the establishment of a VNC connection by a VNC module 312. Enabling the base application on the client device to initiate the VNC connection can greatly simplify establishing the connection in that the device's security configuration may make it difficult for a remote user to initiate the connection. Similarly, when the communication between the remote device and the mobile device is complete (e.g., as detected by the base application), termination of the VNC connection may be effected.

In situations where the event triggering the VNC connection is a request from a remote device (or in any situation in which two-way communication is established with the mobile device), it is desirable to determine whether the requester is entitled to access the mobile device. This may be accomplished, for example, through the use of tokens or digital certificates to authenticate communications between mobile users and the remote devices.

The accumulated information about their mobile users, e.g., conformance or non-conformance with IT policies, may be communicated to IT personnel in a number of ways. For example, if a mobile device connects to an unsecure network without wireless encryption against his company's IT policies, an alert could be generated which results in an email being transmitted to IT personnel associated with NOC 114. Alternatively, the status of a graphical representation of the non-conforming user's machine in, for example, a web interface having representations of multiple users displayed, might change, e.g., from green to red. Then, by selecting the graphical representation, the IT personnel could be provided with more detailed information regarding the status of that machine.

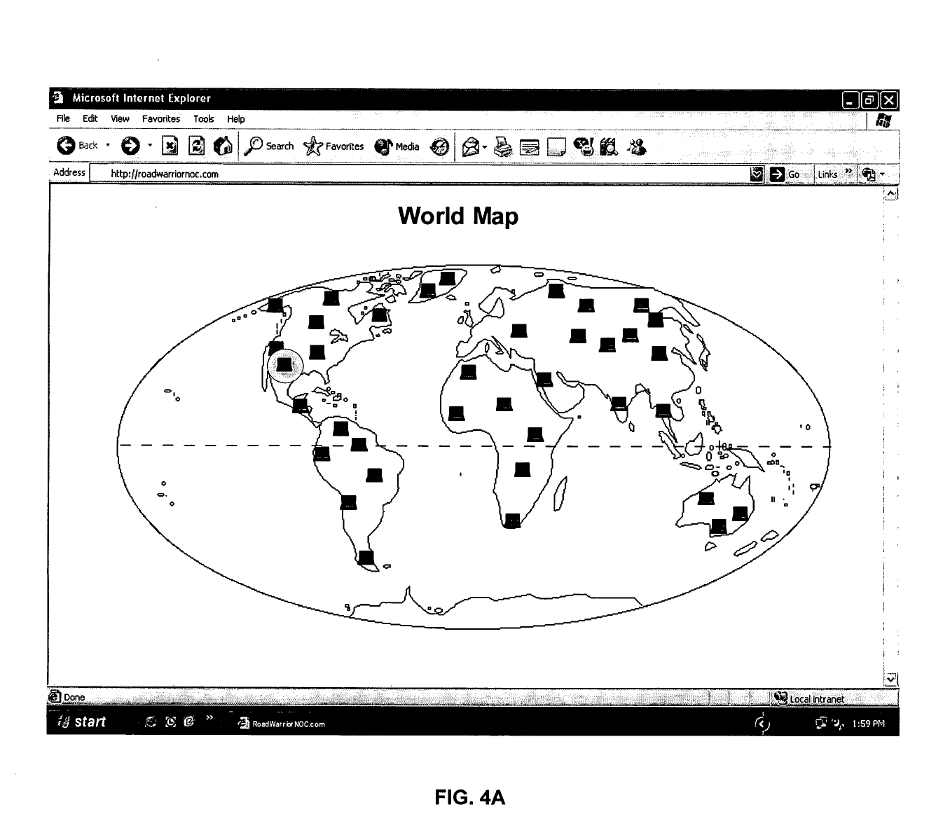

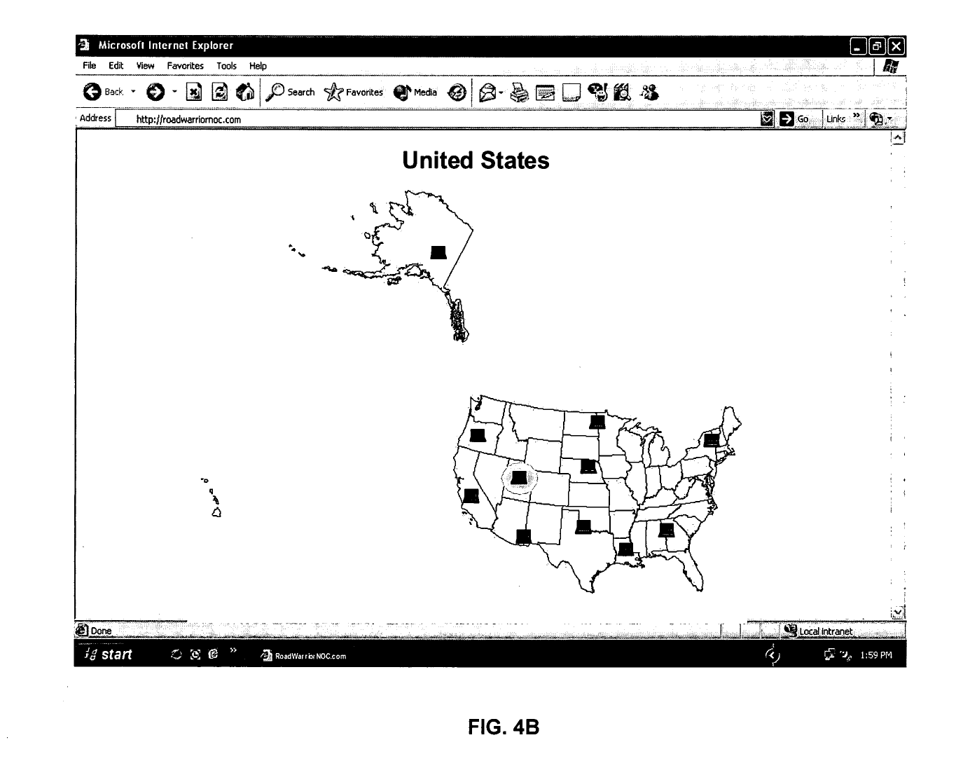

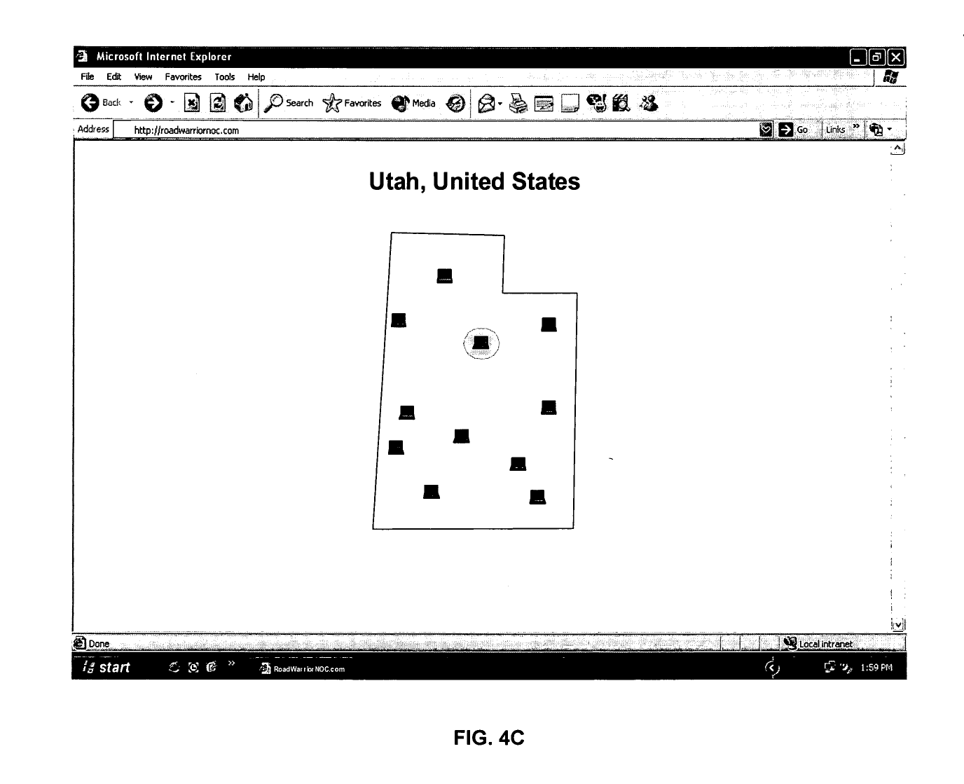

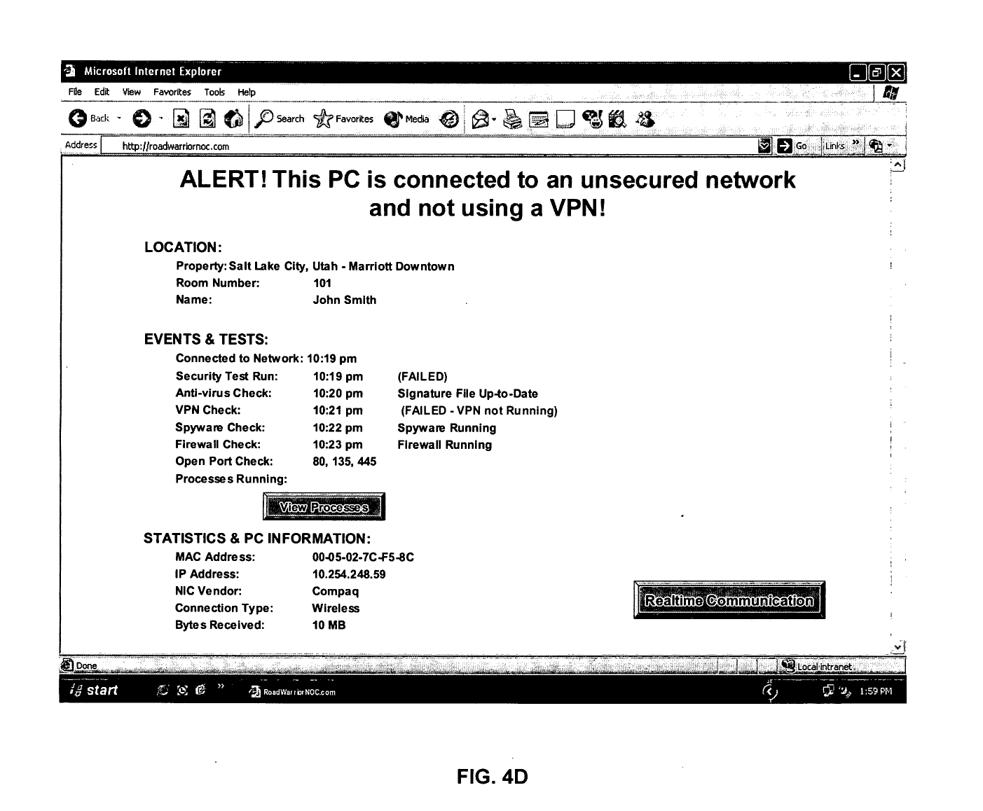

FIGS. 4A-4D are exemplary screenshots illustrating interfaces for monitoring mobile users according to a specific embodiment of the invention. The screenshot of FIG. 4A shows a global view that might be presented to the IT personnel of a global corporation having laptop icons for each country or region in which the enterprise currently has mobile users. Alerts associated with a particular region or country could be indicated, for example, by coloring the corresponding laptop icon red. By selecting a red laptop icon (e.g., the circled icon in the southwest region of the U.S., IT personnel could drill down as shown in FIG. 4B and then again in FIG. 4C to get to a view in which the laptop icons correspond to individual devices. Selection of the individual device would then result in presentation of an interface such as the one shown in FIG. 4D in which detailed information regarding the corresponding device is provided.

Embodiments of the invention may provide a near real-time collaboration tool between mobile users and IT personnel at a company NOC. According to such embodiments, IT personnel are able to communicate with non-conforming users or with users experiencing difficulties to achieve compliance with IT policy or to provide other types of support. For example, when IT personnel are notified of an event such as, for example, one of their users accessing an unsecure network, an interface might be provided to the IT personnel in which they could generate a message to the user alerting the user and possibly providing information or documentation regarding how to correct the situation. Such messaging could be enabled in conjunction with the background application residing on the mobile computing device. Additionally, the messaging functionality in the background application may facilitate two-way communication, enabling remote users to request IT support. As discussed above, communications between IT personnel and the mobile user could be effected using authentication (e.g., tokens, certificates) and encryption (e.g., IPsec tunnels). And as discussed above, the background application may also be configured to facilitate opening of a VNC connection to enable corporate IT personnel to modify settings on the mobile device VNC.

Depending upon the network environment in which the invention is implemented and according to more specific embodiments of the invention, varying amounts and types of mobile user data, as well as value-added services relating to such data, may be provided. According to a specific embodiment, a network architecture is provided to which mobile users may securely connect when they are away from their home network which, in addition to the functionalities discussed above, enables an even richer data set to be generated and presented to IT personnel. An example of such a network architecture is shown in FIG. 5. Additional information about the nature of such an architecture is provided in U.S. patent application Ser. No. ______ for SECURITY FOR MOBILE DEVICES IN A WIRELESS NETWORK filed on the same day as the present application (Attorney Docket No. STSNP007), the entire disclosure of which is incorporated herein by reference for all purposes.

FIG. 5 is a diagram of an exemplary network environment in which more specific embodiments of the invention may be implemented. Network 500 enables an “end-to-end” solution by which mobile devices (e.g., business traveler laptops) may be provided with secure access to the Internet. Because of the nature of this network, additional functionalities may be implemented beyond those described above with reference to the more generalized network of FIG. 1. The following discussion assumes that network 500 is a packet switching network in which the various network devices shown communicate via TCP/IP and associated protocols. It should be noted, however, that network 500 is merely an exemplary environment in which various aspects of the invention may be practiced, and that the details of network 500 should not necessarily be considered as limiting the invention. Rather, it will be understood that many of the basic techniques described herein may be implemented in a wide variety of network environments having only some of the characteristics of network 500 without departing from the scope of the invention.

Network 500 is characterized by a multi-layered architecture which includes three main tiers, i.e., properties 502, service regions 504, and central services 506, all linked by high-speed connections. Properties 502 may be, for example, hotels, conference centers, cafés, and any type of wireless “hotspot.” Each property 502 has its own “closed” local network 508 that provides wired and/or wireless access to mobile devices (503) at that property. Such mobile devices may be, for example, laptops or handheld computing devices which are wired and/or wireless. Each local network 508 includes a gateway 510 which secures and manages local broadband traffic. According to various specific embodiments, gateway 510 may comprise, for example, the HEP 502 from STSN of Salt Lake City, Utah, or the USG II from Nomadix of Newbury Park, Calif. Of course, it will be understood that a wide variety of network device types and groups of network devices may be configured to perform the described functionality of such a gateway without departing from the scope of the invention.

To facilitate efficient support, management and security, properties 502 are associated with service regions 504. Each service region 504 features a secure regional point of presence (POP) 512 which may include multiple service region servers 514 and a database 516. When a mobile device at a property 502 accesses the network, the connection is passed through gateway 510 to the appropriate regional POP 512 via a private high-speed circuit (e.g., a T-1, DS-3, OC-3).

Each regional POP 512 has a direct, high-speed connection to the Internet backbone 518. In addition, each POP 512 links to a central data center 520 which enables consolidated reporting, network monitoring, customer service, and quality assurance for all of properties 502. When a device connects to a property network, the equipment and services at each level of network 500 work together to ensure a safe, simple broadband experience that can easily be tracked and supported.

According to various embodiments, gateway 510 may enable both wired and wireless connectivity. For example, such embodiments may support Wi-Fi-based solutions (as represented by wireless access nodes 511A) and DSL, PNA, and Ethernet solutions (as represented by wired access nodes 511B). Gateway 510 facilitates high-speed Internet access from a wide variety of locations at the property. In some embodiments, multiple gateways are installed on a property. For example, in a hotel implementation, one gateway might manage guest rooms while another manages a conference space. Wireless solutions may be implemented according to IEEE 802.11b, 802.11g, 802.11a, 802.16, etc.

Gateway 510 is central to a specialized local area network, i.e., LAN 508. This is a closed, dedicated network for local broadband traffic. LAN 508 provides the infrastructure required for connectivity to the Internet, including any of Customer Premises Equipment (CPE), Digital Subscriber Line Access Multiplexers (DSLAMs), and wireless access points (WAPs). Gateway 510 is intended to be compatible with a broad range of equipment, and the configurations of LANs 508 can vary widely. All hardware devices connected to LAN 508 via wireless access nodes 511A and wired access nodes 511B, including guest mobile devices, are monitored by gateway 510 which regularly reports to its regional POP 512. In this way, broadband service can be monitored, supported, and protected all the way down to individual mobile devices on LANs 508. Wireless access nodes 511A may comprise, for example, the CN320 from Colubris Networks of Waltham, Mass. Wired access nodes 511B may comprise, for example, the Catalyst 2950-24 LRE Switch from Cisco Systems of San Jose, Calif. Of course, it will be understood that a wide variety of devices are suitable for implementing the described functionality.

According to various embodiments, gateway 510 accepts any guest hardware configuration, thus eliminating the necessity for manual configuration and reducing the likelihood of end-users “tweaks” to company mandated laptop configurations which can create holes in security mechanisms.

Gateway 510 may also connect to the property's core network (not shown), e.g., a hotel's network infrastructure. In such implementations, firewall technology and/or intrusion detection and prevention systems (IDS/IPS) may be used to shield the core network from unauthorized intrusions. A router on the core network may be the mechanism by which gateway 510 transfers data to and from its regional POP 512.

As mentioned above, network 500 is divided into geographically-defined service regions 504. Each region 504 includes a secure regional POP 512 which supports multiple properties 502. The traffic to and from a connected property 502 passes through a regional POP 512, thus providing another layer of security, redundancy and quality control.

Regional POPs 512 may include one or a cluster of redundant service region servers (SRS) 514 and regional database 516. Regional POPs 512 may be co-located with third-party ISPs which provide traffic to and from LANs 508 with a direct, high-speed connection to the Internet backbone 518. Enterprise-grade firewalls 517 at POPs 512 protect properties 502 and their guests from hackers, viruses, worms and other malicious attacks. It should be understood that firewalls 517 may be conventional firewalls or, alternatively, include additional functionality such as intrusion detection and intrusion prevention systems (IDS and IPS).

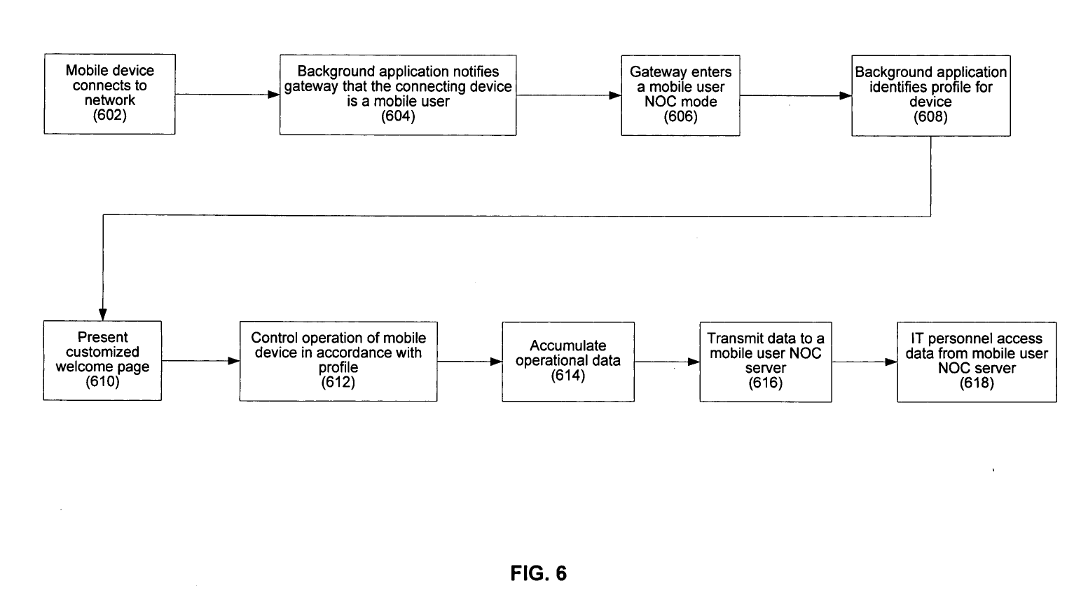

According to a specific embodiment of the invention, regional POPs 512 may also be configured to receive accumulated device operation data and to host a mobile user NOC interface by which corporate IT personnel may have visibility into the usage patterns and behaviors of their mobile users. An exemplary embodiment will be described below with reference to FIG. 6.

According to the implementation shown in FIG. 5, regional POPs 512 are linked to central data center 520 which houses the network's central database 522 and services. This combination of multiple regional databases and a single network-wide repository ensures speed and fail-over reliability, while facilitating the delivery of centralized management, reporting and technical support to properties 502. Central data center 520 and regional POPs 512 are enterprise grade, and engineered for maximum security and data availability.

As mentioned above, properties 502 may connect to network 500 via a digital link provided and controlled by the operator of network 500. Alternatively, this connectivity may be achieved using MPLS layered switching technology. In either case, such an approach ensures the highest levels of reliability, security and speed. That is, this private-line connectivity gives properties 502 a single point of contact which is provisioned, installed, supported, and managed by the network provider.

The “end-to-end” architecture shown in FIG. 5 is characterized by a number of advantages. For example, broadband Internet connectivity for disparate devices may be provided in a matter of seconds because of the “plug-and-play” nature of the network. Straightforward connectivity may also be provided in such an environment by providing, for example, robust support for virtual private networks, i.e., VPNs (described below).

As will be described, network 500 automatically assigns each guest device a private IP address from a pool of private IP addresses. This may be done without requiring the release of any pre-assigned “static” IP on the laptop. Each connected device may therefore be identified on the network by two private IP addresses, i.e., the static address assigned by the guest's corporate network and the temporary address assigned by network 500. The use of private IP addresses in this context provides significant security benefits in that they are readily distinguishable from public IP addresses, and are therefore more amenable to preventing unauthorized communications from outside the local network.

When necessary, network 500 can enable guests to access the Internet or a corporate VPN by mapping their device to a public IP address. Network 500 maintains a pool of public IP addresses that can be dynamically assigned anywhere on the network to meet surges or concentrations of guest demand. To connect devices to the Internet, the network performs two network address translations (NATs). The first, performed by gateway 510, maps a device's static IP address to the private IP address assigned by network 500. The second, which may, for example, be performed at firewall/IDS/IPS 517, maps the assigned private IP address to a public IP address. This double translation provides another layer of protection for guest computers. Network 500 also provides Address Resolution Protocol (ARP) control which enables every connected device to be identified by its unique machine Media Access Control (MAC) address for controlling or limiting unauthorized ARP requests or denial of service (DOS) attacks.

As mentioned above, a network architecture such as shown in and described with reference to FIG. 5 enables a rich data set to be developed relating to the operation of a mobile device connecting to the network. Referring now to FIG. 6, when a mobile device (e.g., 503) having a mobile user NOC background application installed connects to network 500 (602), the background application notifies gateway 510 that the connecting device is a mobile user (604) in response to which gateway 510 enters a mobile user NOC mode with respect to transmission from that device (606).

For example, in such a mode, the background application could identify specific profile or set of policies for the corporation associated with the device (608), and a customized mobile user welcome page could be presented to the user of the mobile device enforcing any form of authentication required by the profile (610). For example, an enterprise could have a profile for its users which mandates that wireless connections be made only via WPA. Thus, if a user associated with that enterprise attempts to connect to network 500 wirelessly without encryption, a welcome page could be presented indicating that the user's enterprise requires connection using WPA and including instructions for doing so.

In another example, if a company wants to enforce token authentication for their VPN, such a mechanism can ensure that when the company's users connect to the network they employ the proper token identification. This provides an additional level of security over and above that already provided by network 500. Operation of the device on the network would then be controlled in accordance with the profile (612). For example, a corporation could have its policy regarding where its users can browse enforced on the network. This could be achieved, for example, by forcing all Internet traffic from an enterprise's mobile devices through the enterprise's home network. Alternatively, devices in network 500 (e.g., gateways 510) may be configured to block attempts by users from a particular enterprise to connect with unauthorized URLs or categories of web sites.

According to a specific embodiment, data regarding the operation and/or operational status of the mobile device are accumulated (614) and transmitted to a remote mobile user NOC server (e.g., SRS 514 at POP 512) either periodically or in real time (616). As described above, these data may be accumulated by a background application or user agent operating on the mobile device. Alternatively, at least some of these data may be accumulated or generated by or in conjunction with other devices on the network, e.g., gateway 510. IT personnel may then access representations of the accumulated data from the mobile user NOC server via the Internet (618) using, for example, a web interface.

It should be noted that, because network 500 is capable of identifying connecting machines as corresponding to a particular corporation (e.g., using previously stored MAC addresses), it is possible with embodiments of the invention implemented on such a network to provide mobile user visibility to remote IT personnel without having agent software stored on the client devices. That is, once a machine is recognized as being associated with a particular corporation, because all traffic on the network is directed through the central gateway, it is possible to accumulate detailed information relating to the operation of individual devices on the network which may then be presented in a mobile user NOC interface as described herein.

A wide variety of value-added features and services are made possible in a network environment like network 500 due to the fact that all of the traffic must pass through a centralized device, e.g., gateway 510. As mentioned above, this enables operational and status data to be generated or accumulated by the gateway. According to such embodiments, visibility into the operation of mobile devices connecting to the network can be provided on a packet-by-packet basis. This level of granularity may be leveraged, for example, to provide detailed statistical information regarding a particular user device, e.g., how many bytes sent and received by that device. Because of its “downstream” position from the user devices, the gateway can identify, for example, when connected devices are sending out virus traffic. In addition, the gateway could alert the mobile user NOC that other devices on the network are attempting (unsuccessfully) to send packets to one of a company's connected employees.

Further detailed information regarding connected devices may also be determined by the network (e.g., by the gateway) by more actively obtaining data from the devices, e.g., through the use of probes, etc. For example, a probe scan could be initiated by the gateway to determine what ports are open for a given device. The results of such a probe could be used, as discussed above, to determine whether the device has been infected by a virus or spyware.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for monitoring mobile computing devices configured for operation in a home network, comprising:
accumulating mobile user data relating to operation of each of the mobile computing devices on at least one remote network which does not include any part of the home network; and
generating a representation of the mobile user data for each of the mobile computing devices which is capable of being presented in a network operations center (NOC) interface substantially in real time.

2. The method of claim 1 wherein accumulation of the mobile user data is accomplished using a background application running on each of the mobile computing devices, the method further comprising receiving the mobile user data from each of the mobile computing devices.

3. The method of claim 1 wherein the mobile user data for each mobile computing device relates to any of geographic location, connection status, security of the remote network, security status, virus status, spyware status, virtual private network status, firewall status, currently running processes, and port status.

4. The method of claim 1 further comprising receiving the mobile user data with a network device on the home network.

5. The method of claim 1 further comprising receiving the mobile user data with a first network device on a service provider network separate from the home network, the method further comprising facilitating presentation of the NOC interface on a second network device on the home network.

6. The method of claim 1 further comprising facilitating presentation of the NOC interface on a remote device.

7. The method of claim 6 wherein facilitating presentation of the NOC interface comprises presenting a graphical user interface with visual representations of each of the mobile computing devices, each visual representation representing a status of the corresponding mobile computing device.

8. The method of claim 1 wherein accumulation of the mobile user data is accomplished using an application on a service provider network separate from the home network, the method further comprising retrieving the mobile user data from each of the mobile computing devices using the application on the service provider network.

9. The method of claim 8 wherein the application is operable to monitor geographic location, connection status, security of the remote network, security status, virus status, spyware status, virtual private network status, firewall status, currently running processes, and port status.

10. The method of claim 1 further comprising facilitating communication of a message from a remote device to a first one of the mobile computing devices.

11. The method of claim 10 wherein the message relates to a mobile computing policy associated with the home network.

12. The method of claim 1 further comprising facilitating communication of a message from a user associated with a first one of the mobile computing devices to a remote device, the message requesting operational support from an information technology specialist associated with the remote device.

13. The method of claim 1 further comprising facilitating messaging between a remote device and the mobile computing devices thereby enabling support by personnel associated with the home network of the operation of the mobile computing devices in the at least one remote network.

14. The method of claim 1 wherein the at least one remote network comprises a first remote network in which all traffic on the first network is directed through a gateway device, the method further comprising receiving packets transmitted from selected ones of the mobile computing devices which are connected to the first network, accumulating additional user data in response to the packets, and generating the representations corresponding to the selected mobile computing devices with reference to both the mobile user data and the additional user data.

15. The method of claim 14 wherein the additional user data for each mobile computing device relates to any of token authentication, traffic volume, packets from other computing devices directed to the selected mobile computing devices, type of traffic, and attempted access to prohibited sites.

16. The method of claim 1 further comprising determining whether a process is running on a first one of the mobile computing devices.

17. The method of claim 16 further comprising determining whether at least one file associated with the process corresponds to a specific version of the at least one file.

18. The method of claim 17 further comprising facilitating updating of the at least one file where the at least one file does not correspond to the specific version.

19. The method of claim 17 wherein the process relates to security of the first mobile computing device.

20. The method of claim 1 further comprising determining with reference to the mobile user data whether operation of a first one of the mobile computing devices conforms with a policy profile corresponding to an enterprise with which the first mobile computing device is associated.

21. The method of claim 20 wherein the representation of the mobile user data corresponding to the first mobile computing device indicates whether operation of the first mobile computing device conforms with the policy profile.

22. The method of claim 20 further comprising facilitating conformance of the operation of the first mobile computing device with the policy profile.

23. The method of claim 22 wherein conformance is facilitated at least in part by facilitating communication between the first mobile computing device and a remote device associated with the enterprise.

24. A network, comprising:
an access node which is operable to receive packets from a plurality of mobile computing devices attempting to access the network, the mobile computing devices being configured for operation in a home network which is separate from the network, the access node being configured to transmit all of the packets received from the mobile computing devices to a gateway on the network regardless of destination addresses associated with the packets;
the gateway which is operable to receive mobile user data relating to operation of each of the mobile computing devices on the network, and facilitate generation of a representation of the mobile user data for each of the mobile computing devices which is capable of being presented in a network operations center (NOC) interface substantially in real time.

25. At least one computer-readable medium having computer program instructions stored therein which are operable to cause at least one computer to monitor operation of a mobile computing device configured for operation in a home network, the computer program instructions comprising:
first instructions for detecting events relating to operation of the mobile computing device on at least one remote network which does not include any part of the home network;
second instructions for accumulating mobile user data relating to the events; and
third instructions for transmitting the mobile user data to a remote platform for presentation in a network operations center (NOC) interface substantially in real time.
